(19) United States
(12) Patent Application Publication
(10) Pub. No.: US 2004/0188377 A1
(43) Pub. Date: Sep. 30, 2004

(54) Carrier handle for a container provided with a neck

(76) Inventor: Fernand Balade, Begles (FR)

Correspondence Address: YOUNG & THOMPSON, 745 SOUTH 23RD STREET 2ND FLOOR, ARLINGTON, VA, 22202

(21) Appl. No.: 10/484,182

(22) PCT Filed: Jul. 15, 2002
(86) PCT No.: PCT/FR02/02504

(30) Foreign Application Priority Data
Jul. 16, 2001 (FR) 01/9457

(51) Int. Cl. A47J 45/00; B65D 23/10

(52) U.S. Cl. 215/396; 294/27.1

(57) ABSTRACT

The invention concerns a carrier handle for a container provided with a cylindrical neck characterised in that it comprises in combination a handle (2) equipped at one end with an inner closed ring (3) whereon is mounted an open half-ring (4) forming between them an angle of about 5 to 15 degrees; the half-ring (4) being arranged in the same plane as the proximal part of the handle (2).

The invention relates to manual handling of heavy loads having a cylindrical gripping portion. A typical example of such a load to be manually manipulated is constituted by a demijohn for water fountains whose usage is widespread in companies and stores.

These demijohns of a capacity of about 20 liters are generally made of a cylindrical container of plastic material, surmounted by a neck of lesser diameter having adjacent its opening a lip projecting from the neck.

These demijohns are adapted for the dispensing furniture generally called water fountains.

Because of their large size and their weight, these demijohns are difficult to handle and to transport.

One of the reasons for this difficulty arises from the fact that because of the relative size of the diameter of the neck (about 6 cm), manual gripping is difficult.

To overcome this drawback, U.S. Pat. No. 4,579,237 has proposed a transport handle constituted by a utensil in the form of a frame with an L-shaped section whose lower leg can be engaged on the neck of a demijohn and whose upper leg forms the gripping portion for the hand. Such a handle is shown schematically in FIG. 1 accompanying the present specification.

This known handle however is not satisfactory because it has the following drawbacks:

it requires the use of two hands for its emplacement on the neck of a demijohn,

it extends higher than the demijohn, which requires the bearer to bend his arm to be able to raise the demijohn above the ground during transport, which renders the transport position uncomfortable.

The present invention seeks to overcome these drawbacks and to provide a very simple and low cost apparatus which permits handling demijohns of water or another receptacle of this type with an extended position of the arm, a good distribution of forces, a firm grip and which will be easier to emplace instinctively with a single gesture.

To this end, the handle according to the invention comprises in combination a handle provided at one end with a lower closed ring surmounted by an open half-ring forming between them an angle of 5 to 15°, the half-ring being disposed in the same plane as the adjacent portion of the handle.

The lower closed ring is adapted to surround the cylindrical neck and to come into swinging abutment with the latter, whilst the upper half-ring is adapted to coact with the upper lip of the neck against which it comes into abutment.

Thanks to the angulation between the lower ring and the upper half-ring, the engagement of the apparatus takes place very simply, it suffices to hold the apparatus with the lower ring in a horizontal position and to engage it about the neck of the demijohn until the upper half-ring will be substantially below the level of the upper lip of the neck; the assembly is then swung forwardly until the forward edge of the half-ring comes into abutment against the lower portion of the neck whilst the upper half-ring comes into contact with the lower portion of the lip of the neck opposite said lower portion of the lower ring.

The tool is thus firmly blocked on the neck of the demijohn and it suffices to continue the swinging movement to raise the assembly above the ground whilst keeping the arm extended. The length of the handle and its diameter ensure a natural high quality grip.

The invention will be better understood from the help of the description which follows of one preferred embodiment, in connection with the accompanying drawings, in which:

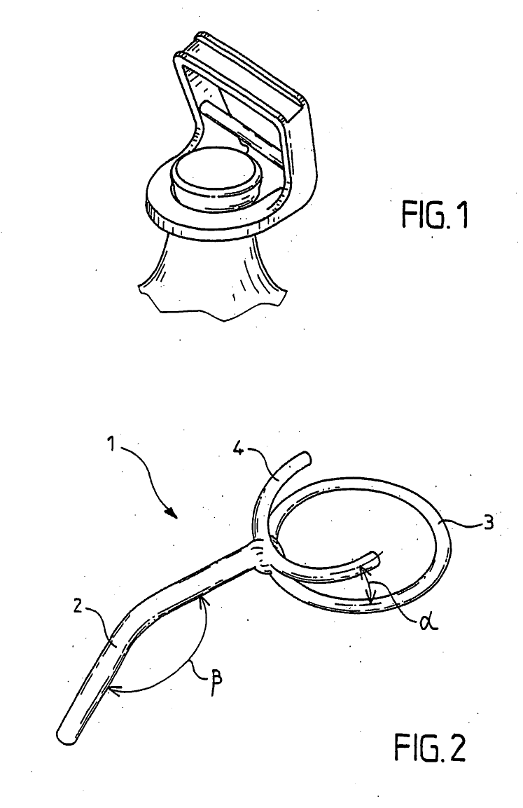

FIG. 2 is a general perspective view of an apparatus according to the invention;

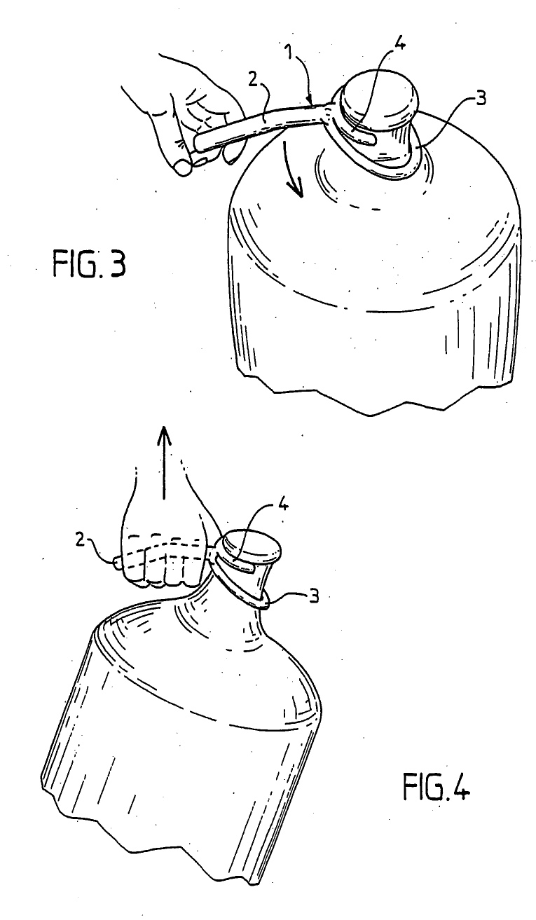

FIG. 3 is a perspective view showing the engagement of the apparatus on the neck of a demijohn of water;

and FIG. 4 is an elevational view of the assembly in the transport position.

As is seen in FIG. 2, the apparatus 1 is constituted by a gripping handle 2 to the end of which are fixed one above the other a lower closed ring 3 and an upper open half-ring 4.

The ring 3 and the half-ring 4 form between them an angle α of about 5° to 15° and preferably 10°. The upper half-ring 4 is, seen from the side, substantially in the same plane as that of the adjacent portion of the handle 2.

The handle has substantially at its middle an angle β of about 175°, corresponding to the natural curvature of the fingers of a closed hand. This arrangement ensures a comfortable and certain grip of the hand on the handle.

Preferably, the diameter of the lower ring 3 will be slightly greater than that of the upper half-ring 4 which fits with very little play about the neck of the receptacle to be transported.

In the case of a demijohn of water of 18 liters, the diameter of the neck is of the order of 6 cm. The diameter of the lower ring 3 will be 7 cm, that of the upper half-ring 4, 6 cm, the length of the handle will be about 12 cm, its bend β being located substantially in its middle.

Preferably, the tool will be made of round iron covered with epoxy paint.

The assembly of the handle 2, of the lower ring 3 and of the upper half-ring 4 can be made by welding.

The diameter of the iron used will be preferably 10 mm for the handle 2, 7 mm for the lower ring 3 and 6 mm for the upper half-ring 4.

To render the grip even more comfortable, the handle 2 could receive a cladding for example in the form of a tube of flexible plastic material.

FIG. 3 shows the emplacement of the apparatus 1 on the neck of a demijohn of water 5; after swinging forwardly, it will be seen that the apparatus is immobilized on the neck by the bearing of the lower ring 3 on the front and the bearing of the upper half-ring 4 on the rear (relative to the handle 2), the upper half-ring 4 being moreover in abutment below the upper lip of the neck.

FIG. 4 shows the assembly in transport position with the arm extended, the angle of the apparatus causing the demijohn to swing into a position in which the distribution of the weight is balanced and the effort of carrying reduced to the minimum.

The invention is not limited to the embodiment described above. In particular, the apparatus could be made of molded material or otherwise so long as it comprises a handle associated with a lower ring disposed at an angle of 5° to 15° below a half-ring located in the same horizontal plane as the adjacent end of the handle.

Similarly, it would not be a departure from the scope of the invention to modify the dimensions of the elements of the apparatus to adapt them to those of the receptacle which it serves to carry.

1. Handle for carrying a receptacle provided with a cylindrical neck, characterized in that it comprises in combination a handle (2) provided at one end with a lower closed ring (3) surmounted by an open half-ring (4) forming between them an angle (α) of about 5 to 15°, the half-ring (4) being disposed in the same plane as the adjacent portion of the handle (2).

2. Handle according to claim 1, characterized in that the angle (α) between the lower ring (3) and the upper half-ring (4) is 10°.

3. Handle according to claim 1, characterized in that the handle (2) has substantially in its middle an angle (β) of about 175°.

4. Handle according to claim 1, characterized in that the diameter of the lower ring (3) is greater than that of the upper half-ring (4).

5. Handle according to claim 1, characterized in that the handle (2) is sheathed.

6. Handle according to claim 1, characterized in that for a receptacle whose diameter of the neck is about 6 cm, the dimensions are as follows:
handle length (2): 12 cm,
diameter of lower ring (3): 7 cm,
diameter of the half ring (4): 6 cm.

7. Handle according to claim 6, characterized in that it is made of round iron covered with epoxy paint.

8. Handle according to claim 2, characterized in that the handle (2) has substantially in its middle an angle (β) of about 175°.

9. Handle according to claim 2, characterized in that the diameter of the lower ring (3) is greater than that of the upper half-ring (4).

10. Handle according to claim 3, characterized in that the diameter of the lower ring (3) is greater than that of the upper half-ring (4).

11. Handle according to claim 8, characterized in that the diameter of the lower ring (3) is greater than that of the upper half-ring (4).

12. Handle according to claim 2, characterized in that for a receptacle whose diameter of the neck is about 6 cm, the dimensions are as follows:
handle length (2): 12 cm,
diameter of lower ring (3): 7 cm,
diameter of the half ring (4): 6 cm.

13. Handle according to claim 3, characterized in that for a receptacle whose diameter of the neck is about 6 cm, the dimensions are as follows:
handle length (2): 12 cm,
diameter of lower ring (3): 7 cm,
diameter of the half ring (4): 6 cm.

14. Handle according to claim 4, characterized in that for a receptacle whose diameter of the neck is about 6 cm, the dimensions are as follows:
handle length (2): 12 cm,
diameter of lower ring (3): 7 cm,
diameter of the half ring (4): 6 cm.

15. Handle according to claim 5, characterized in that for a receptacle whose diameter of the neck is about 6 cm, the dimensions are as follows:
handle length (2): 12 cm,
diameter of lower ring (3): 7 cm,
diameter of the half ring (4): 6 cm.
